(19) United States
(12) Patent Application Publication
(10) Pub. No.: US 2013/0148618 A1
(43) Pub. Date: Jun. 13, 2013

(54) METHOD AND APPARATUS FOR PROVIDING FOR MULTIPLEXED USE OF A RESOURCE ON A TRANSMISSION MEDIUM

(71) Applicants: David Navratil, Helsinki (FI); Simon Paul Davis, Hampshire (GB)

(72) Inventors: David Navratil, Helsinki (FI); Simon Paul Davis, Hampshire (GB)

(73) Assignee: NOKIA CORPORATION, Espoo (FI)

(21) Appl. No.: 13/817,552

(22) PCT Filed: Aug. 19, 2010
(86) PCT No.: PCT/IB10/53759

§ 371 Date: Feb. 19, 2013

(51) Int. Cl. H04W 72/04

(52) U.S. Cl. CPC H04W 72/04
USPC 370/329

(57) ABSTRACT

A method, apparatus and computer program product are provided in order to allow for greater multiplexing of a resource on a transmission medium. The method may provide for transmission of a flag which indicates to a subset of mobile terminals that a resource, such as an uplink packet data channel, on a transmission medium that is shared by the subset will be allocated to a respective one of the subset. The method may also provide for transmission of an identity of a respective one of the subset and may then receive communications from the respective one of the subset utilizing the resource on a transmission medium.

### TECHNOLOGICAL FIELD

An example embodiment of the present invention relates generally to the allocation of a resource on a transmission medium and, more particularly, to the multiplexed use of a resource, such as a packet data channel, on a transmission medium.

### BACKGROUND

In communication networks, multiple users, such as multiple mobile terminals, may desire to utilize the limited resources on a transmission medium. For example, a transmission medium may support a limited number of packet data channels with multiple users, such as multiple mobile terminals attempting to utilize the packet data channels, such as for transmission of data to a network entity or to another mobile terminal.

In an effort to increase access to the limited resources on a transmission medium, techniques have been developed in order to provide for multiplexed use of the limited resources by a plurality of users, such as a plurality of mobile terminals. In a Global System for Mobile communications (GSM) Enhanced Data rats for Global Evolution (EDGE) radio access network (GERAN), for example, an uplink state flag (USF) is defined. The USF is a three-bit field which provides a eight unique values. The eight unique values of the USF are assigned to different users, such as different mobile terminals. The USF may be included in the header of each radio link control/medium access control (RLC/MAC) block on a downlink packet data channel (PDCH). The USF identifies the particular user, such as the particular mobile terminal, that is authorized to utilize the uplink PDCH such that a temporary block flow (TBF) may be supported from the respective user via the uplink PDCH. As such, the USF may be utilized in GERAN to control the multiplexing of different users, such as different mobile terminals, and the corresponding TBFs onto an uplink PDCH.

### BRIEF SUMMARY

A method, apparatus and computer program product are therefore provided in accordance with an example embodiment of the present invention in order to allow for greater multiplexing of a resource on a transmission medium. For example, the method, apparatus and computer program product of one embodiment may provide for increased multiplexing of an uplink packet data channel between a plurality of users, such as a plurality of mobile terminals. By providing for increased levels of multiplexing, greater utilization of the resources on a transmission medium may be provided.

In one embodiment, a method is provided that provides for transmission of a flag which indicates to a subset of mobile terminals that a resource on a transmission medium that is shared by the subset will be allocated to a respective one of the subset. The method of this embodiment also provides for transmission of an identity of a respective one of the subset and then receives communications from the respective one of the subset utilizing the resource on a transmission medium. In an example in which the resource on the transmission medium includes an uplink data channel, the receipt of communication may include the receipt of data from the respective one of the subset via the uplink data channel.

The method of one embodiment may also include providing for transmission of an identity of another one of the subset to at least the respective one of the subset and the another one of the subset following receipt of communications from the respective one of the subset. In this embodiment, the method may also thereafter receive communications from the another one of the subset utilizing the resource on the transmission medium while the communications from the respective one of the subset have been discontinued. The method of one embodiment may also include the receipt of an indication from a mobile terminal that the mobile terminal support the method of multiplexed use of the resource on the transmission medium. In this embodiment, the method may provide for transmission of a response to the indication from the mobile terminal that indicates whether the mobile terminal should await reception of the identity of the mobile station prior to commencing communications in response to reception of the flag. The method of this embodiment may also include the receipt of indications from a plurality of mobile terminals indicating that the mobile terminals support the method of multiplexed use of the resource on the transmission medium and providing for transmission of a single response to each of a plurality of mobile terminals.

An apparatus is also provided in accordance with one embodiment which includes at least one processor and at least one memory storing computer program code. The at least one memory and the stored computer program code are configured, with the at least one processor, to cause the apparatus to at least provide for transmission of a flag which indicates to a subset of mobile terminals that a resource on a transmission medium that is shared by the subset will be allocated to a respective one of the subset. According to this embodiment, the at least one memory and the stored computer program code are also configured, with the at least one processor, to cause the apparatus to provide for transmission of an identity of a respective one of the subset and then receive communications from the respective one of the subset utilizing the resource on a transmission medium. In an example in which the resource on the transmission medium includes an uplink data channel, the receipt of communication may include the receipt of data from the respective one of the subset via the uplink data channel.

The at least one memory and the stored computer program code may also be configured, with the at least one processor, to cause the apparatus to provide for transmission of an identity of another one of the subset to at least the respective one of the subset and the another one of the subset following receipt of communications from the respective one of the subset. In this embodiment, the at least one memory and the stored computer program code may also be configured, with the at least one processor, to cause the apparatus to thereafter receive communications from the another one of the subset utilizing the resource on the transmission medium while the communications from the respective one of the subset have been discontinued. The at least one memory and the stored computer program code may also be configured, with the at least one processor, to cause the apparatus to receive an indication from a mobile terminal that the mobile terminal supports multiplexed use of the resource on the transmission medium. In this embodiment, the at least one memory and the stored computer program code may also be configured, with the at least one processor, to cause the apparatus to provide for transmission of a response to the indication from the mobile terminal that indicates whether the mobile terminal should await reception of the identity of the mobile station prior to commencing communications in response to reception of the flag. The at least one memory and the stored computer program code may also be configured, with the at least one processor, to cause the apparatus of this embodiment to receive indications from a plurality of mobile terminals indicating that the mobile terminals support multiplexed use of the resource on the transmission medium and provide for transmission of a single response to each of a plurality of mobile terminals.

A computer program product is also provided in accordance with another embodiment that includes at least one computer-readable medium having computer-readable program instructions stored therein. The computer-readable program instructions include program instructions configured to provide for transmission of a flag which indicates to a subset of mobile terminals that a resource on a transmission medium that is shared by the subset will be allocated to a respective one of the subset. In accordance with this embodiment, the computer-readable program instructions also include program instructions configured to provide for transmission of an identity of a respective one of the subset and then receive communications from the respective one of the subset utilizing the resource on a transmission medium. In an example in which the resource on the transmission medium includes an uplink data channel, the receipt of communication may include the receipt of data from the respective one of the subset via the uplink data channel.

The computer-readable program instructions may also include program instructions configured to provide for transmission of an identity of another one of the subset to at least the respective one of the subset and the another one of the subset following receipt of communications from the respective one of the subset. In this embodiment, the computer-readable program instructions may also include program instructions configured to thereafter receive communications from the another one of the subset utilizing the resource on the transmission medium while the communications from the respective one of the subset have been discontinued. The computer-readable program instructions of one embodiment may include program instructions configured to receive an indication from a mobile terminal that the mobile terminal supports multiplexed use of the resource on the transmission medium. In this embodiment, the computer-readable program instructions may include program instructions configured to provide for transmission of a response to the indication from the mobile terminal that indicates whether the mobile terminal should await reception of the identity of the mobile station prior to commencing communications in response to reception of the flag. The computer-readable program instructions of this embodiment may also include program instructions configured to receive indications from a plurality of mobile terminals indicating that the mobile terminals support multiplexed use of the resource on the transmission medium and providing for transmission of a single response to each of a plurality of mobile terminals.

In a further embodiment, an apparatus is provided that includes means for providing for transmission of a flag which indicates to a subset of mobile terminals that a resource on a transmission medium that is shared by the subset will be allocated to a respective one of the subset. The apparatus of this embodiment also includes means for providing for transmission of an identity of a respective one of the subset and then receives communications from the respective one of the subset utilizing the resource on a transmission medium. In an example in which the resource on the transmission medium includes an uplink data channel, the receipt of communication may include the receipt of data from the respective one of the subset via the uplink data channel.

The apparatus of one embodiment may also include means for providing for transmission of an identity of another one of the subset to at least the respective one of the subset and the another one of the subset following receipt of communications from the respective one of the subset. In this embodiment, the apparatus may also include means for thereafter receiving communications from the another one of the subset utilizing the resource on the transmission medium while the communications from the respective one of the subset have been discontinued. The apparatus of one embodiment may also include means for receiving an indication from a mobile terminal that the mobile terminal supports multiplexed use of the resource on the transmission medium. In this embodiment, the apparatus may include means for providing for transmission of a response to the indication from the mobile terminal that indicates whether the mobile terminal should await reception of the identity of the mobile station prior to commencing communications in response to reception of the flag. The apparatus of this embodiment may also include means for receiving indications from a plurality of mobile terminals indicating that the mobile terminals support multiplexed use of the resource on the transmission medium and providing for transmission of a single response to each of a plurality of mobile terminals.

In another embodiment, a method is provided that includes receiving a flag which indicates that a resource on a transmission medium that is shared by a subset of mobile terminals will be allocated to respective one of the subset. The method of this embodiment also includes receiving an identity of the respective one of the subset to which the resource on a transmission medium is allocated and providing for transmission utilizing the resource on a transmission medium. For example, the resource on the transmission medium may include an uplink data channel such that the provision for transmission includes providing for transmission of data via the uplink data channel.

In one embodiment, the method further includes receiving an identity of another one of the subset following the transmission utilizing the resource on the transmission medium and thereafter discontinuing the transmission utilizing the resource on the transmission medium. The method of one embodiment may also include providing for transmission of an indication that a mobile terminal support the method of multiplexed use of the resource on the transmission medium. In this embodiment, the method may receive a response to the indication that indicates whether the mobile terminal should await reception of the identity of the mobile station prior to commencing communications in response to reception of the flag.

An apparatus is also provided in accordance with one embodiment which includes at least one processor and at least one memory storing computer program code. The at least one memory and the stored computer program code are configured, with the at least one processor, to cause the apparatus to at least receive a flag which indicates that a resource on a transmission medium that is shared by a subset of mobile terminals will be allocated to respective one of the subset. In accordance with this embodiment, the at least one memory and the stored computer program code are also configured, with the at least one processor, to cause the apparatus to receive an identity of the respective one of the subset to which the resource on a transmission medium is allocated and provide for transmission utilizing the resource on a transmission medium. For example, the resource on the transmission medium may include an uplink data channel such that the provision for transmission includes providing for transmission of data via the uplink data channel.

In one embodiment, the at least one memory and the stored computer program code are also configured, with the at least one processor, to cause the apparatus to receive an identity of another one of the subset following the transmission utilizing the resource on the transmission medium and thereafter discontinue the transmission utilizing the resource on the transmission medium. The at least one memory and the stored computer program code of one embodiment are also configured, with the at least one processor, to cause the apparatus to provide for transmission of an indication that a mobile terminal support multiplexed use of the resource on the transmission medium. In this embodiment, the at least one memory and the stored computer program code may also be configured, with the at least one processor, to cause the apparatus to receive a response to the indication that indicates whether the mobile terminal should await reception of the identity of the mobile terminal prior to commencing communications in response to reception of the flag.

A computer program product is also provided in accordance with another embodiment that includes at least one computer-readable medium having computer-readable program instructions stored therein. The computer-readable program instructions include program instructions configured to receive a flag which indicates that a resource on a transmission medium that is shared by a subset of mobile terminals will be allocated to respective one of the subset. In this embodiment, the computer-readable program instructions also include program instructions configured to receive an identity of the respective one of the subset to which the resource on a transmission medium is allocated and provide for transmission utilizing the resource on a transmission medium. For example, the resource on the transmission medium may include an uplink data channel such that the provision for transmission includes providing for transmission of data via the uplink data channel.

In one embodiment, the computer-readable program instructions also include program instructions configured to receive an identity of another one of the subset following the transmission utilizing the resource on the transmission medium and thereafter discontinuing the transmission utilizing the resource on the transmission medium. The computer-readable program instructions of one embodiment also include program instructions configured to provide for transmission of an indication that a mobile terminal supports multiplexed use of the resource on the transmission medium. In this embodiment, the computer-readable program instructions may include program instructions configured to receive a response to the indication that indicates whether the mobile terminal should await reception of the identity of the mobile station prior to commencing communications in response to reception of the flag.

In a further embodiment, an apparatus is provided that includes means for receiving a flag which indicates that a resource on a transmission medium that is shared by a subset of mobile terminals will be allocated to respective one of the subset. The apparatus of this embodiment also includes means for receiving an identity of the respective one of the subset to which the resource on a transmission medium is allocated and means for providing for transmission utilizing the resource on a transmission medium. For example, the resource on the transmission medium may include an uplink data channel such that the provision for transmission includes providing for transmission of data via the uplink data channel.

In one embodiment, the apparatus further includes means for receiving an identity of another one of the subset following the transmission utilizing the resource on the transmission medium and thereafter discontinuing the transmission utilizing the resource on the transmission medium. The apparatus of one embodiment may also include means for providing for transmission of an indication that a mobile terminal supports multiplexed use of the resource on the transmission medium. In this embodiment, the apparatus may include means for receiving a response to the indication that indicates whether the mobile terminal should await reception of the identity of the mobile terminal prior to commencing communications in response to reception of the flag.

### BRIEF DESCRIPTION OF THE DRAWINGS

Having thus described certain example embodiments of the present invention in general terms, reference will now be made to the accompanying drawings, which are not necessarily drawn to scale, and wherein:

FIG. 1 is a block diagram of a wireless communication system that may be configured in accordance with an example embodiment of the present invention;

FIG. 2 is a schematic block diagram of a network entity that may be configured in accordance with an example embodiment of the present invention;

FIG. 3 is a block diagram of a mobile terminal that may be configured in accordance with an example embodiment of the present invention;

FIG. 4 is a flow chart illustrating operations performed by a network entity in accordance with an example embodiment of the present invention;

FIG. 5 is a signal flow diagram between a base terminal subsystem (BSS) and a mobile terminal (MT) in accordance with one example embodiment of the present invention;

FIG. 6 is a signal flow diagram between a base terminal subsystem (BSS) and a mobile terminal (MT) in accordance with another example embodiment of the present invention;

FIG. 7 is a signaling flow diagram between a BSS and a plurality of mobile terminals in accordance with yet another example embodiment of the present invention; and

FIG. 8 is a flow chart illustrating the operations performed by a mobile terminal in accordance with an example embodiment of the present invention.

### DETAILED DESCRIPTION

Some embodiments will now be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments. Thus, use of any such terms should not be taken to limit the spirit and scope of various embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

The use of an uplink state flag (USF) has permitted the multiplexed use of a resource on a transmission medium, such as an uplink packet data channel (PDCH), so that a plurality of users, such as a plurality of mobile terminals, may share the resource. However, the maximum number of mobile terminals that may share the resource is limited by the size of the USF. In a GERAN system, the USF is comprised of three bits such that a maximum of eight mobile terminals may be multiplexed on the uplink PDCH. In some instances, however, it may be desirable for additional mobile terminals to share the uplink PDCH with eight mobile terminals being insufficient. In this regard, the number of mobile terminals that may be multiplexed on an uplink PDCH may be insufficient since the number of mobile terminals in a GERAN system is anticipated to increase due to radio frequency re-farming. Additionally, the number of mobile terminals in a GERAN system is anticipated to increase as new devices, such as smart meters, are deployed. Further, improvements in the spectrum efficiency of the GERAN physical layer have allowed for increased data rates, such as double data rates, in comparison to prior releases. As such, a GERAN system may now support approximately twice the number of mobile terminals operating concurrently with the same data rates. For these and other reasons, it may therefore be desirable to allow for increased numbers of users, such as increased numbers of mobile terminals, to share a resource on a transmission medium, such as by sharing an uplink PDCH.

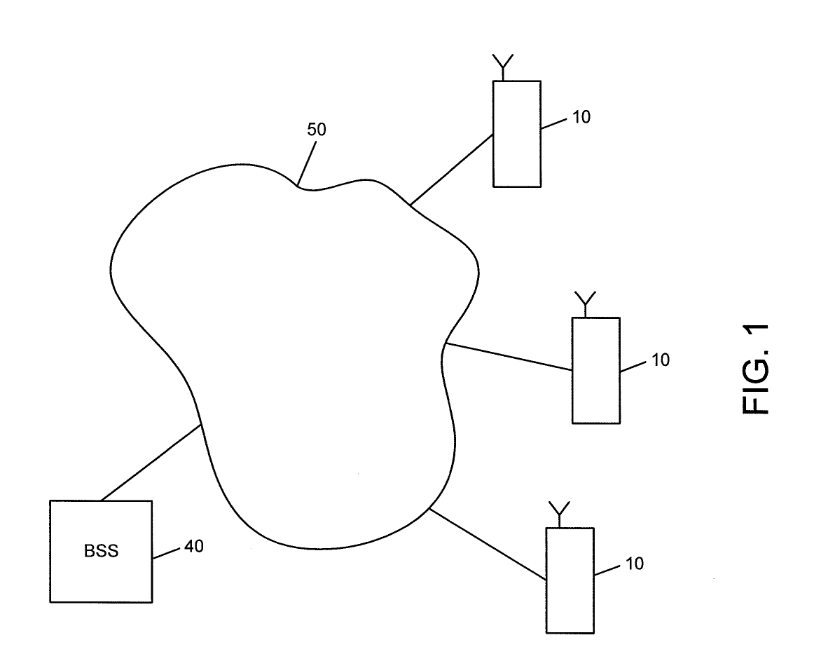

One example of a network configuration that may employ an example embodiment of the present invention is depicted in FIG. 1 in which a wireless communications system is depicted. As shown in FIG. 1, a system in accordance with an example embodiment includes a plurality of communication devices (for example, mobile terminals 10) that may each be capable of communication with a network 50. The communications devices of the system may be able to communicate with network devices, such as a base station system (BSS) 40 or with each other via the network 50.

In an example embodiment, the network 50 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 50. Although not necessary, in some embodiments, the network 50 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminals 10 may be capable of communication with each other via the network 50 and each may include an antenna or antennas for transmitting signals to and for receiving signals from the BSS 40, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (for example, personal computers, server computers or the like) may be coupled to the mobile terminals 10 via the network 50. By directly or indirectly connecting the mobile terminals 10 and other devices to the network 50, the mobile terminals 10 and the other devices may be enabled to communicate with each other and/or the network, for example, according to numerous communication protocols including Hypertext Transfer Protocol (HTTP) and/or the like, to thereby carry out various communication or other functions of the mobile terminal 10 and the other communication devices, respectively. The mobile terminals 10 may be enabled to communicate with the network 50 and other communication devices by any of numerous different access mechanisms. For example, mobile access mechanisms such as wideband code division multiple access (W-CDMA), CDMA2000, GSM, general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

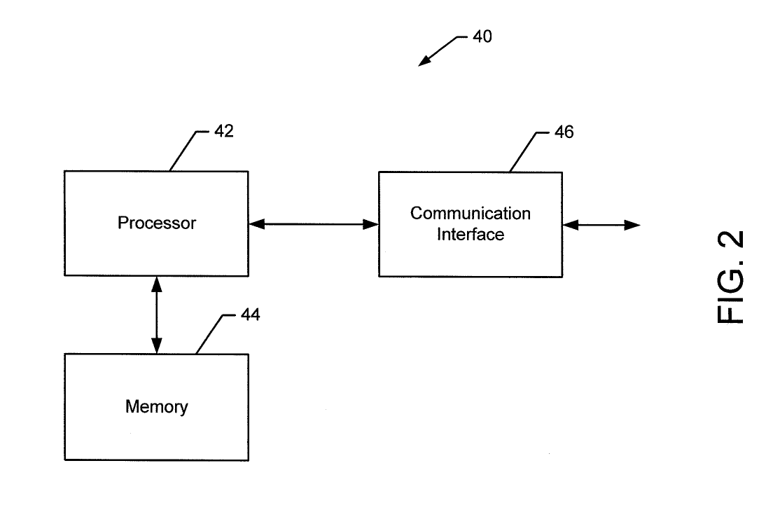

FIG. 2 illustrates a block diagram of an apparatus for facilitating increased multiplexing of a resource on a transmission medium according to an example embodiment of the invention. The apparatus of FIG. 2 may be embodied, for example, by a BSS 40 as described below by way of example or by another network entity. However, it should be noted that the components, devices or elements described below may not be mandatory and thus some may be omitted in certain embodiments. Additionally, some embodiments may include further components, devices or elements beyond those shown and described herein. In the illustrated embodiment, however, the apparatus may include or otherwise be in communication with various means, such as one or more of a processor 42, memory 44 and communication interface 46 for performing the various functions herein described. These means of the apparatus as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 44) that is executable by a suitably configured processing device (for example, the processor 42), or some combination thereof.

The processor 42 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 42 comprises a plurality of processors. The plurality of processors may be in operative communication with each other and may be collectively configured to perform one or more functionalities of the apparatus as described herein. The plurality of processors may be embodied on a single computing device or may be distributed across a plurality of computing devices collectively configured to perform one or more functionalities of the apparatus as described herein. In some example embodiments, the processor 42 is configured to execute instructions stored in the memory 44 or otherwise accessible to the processor. These instructions, when executed by the processor 42, may cause the apparatus to perform one or more of the functionalities of the apparatus as described herein. As such, whether configured by hardware or software methods, or by a combination thereof, the processor 42 may comprise an entity capable of performing operations according to an example embodiment of the present invention while configured accordingly. Thus, for example, when the processor 42 is embodied as an ASIC, FPGA or the like, the processor may comprise specifically configured hardware for conducting one or more operations described herein. Alternatively, as another example, when the processor 42 is embodied as an executor of instructions, such as may be stored in the memory 44, the instructions may specifically configure the processor 42 to perform one or more algorithms and operations described herein.

The memory 44 may comprise, for example, volatile memory, non-volatile memory, or some combination thereof. Although illustrated in FIG. 2 as a single memory, the memory 44 may comprise a plurality of memories. The plurality of memories may be embodied on a single computing device or distributed across a plurality of computing devices that may collectively comprise the apparatus. In various embodiments, the memory 44 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 44 may be configured to store information, data, applications, instructions, or the like for enabling the apparatus 44 to carry out various functions in accordance with various example embodiments. For example, in some example embodiments, the 44 is configured to buffer input data for processing by the processor 42. Additionally or alternatively, in some example embodiments, the 44 is configured to store program instructions for execution by the processor 42.

The communication interface 46 may be embodied as any device or means embodied in circuitry, hardware, a computer program product comprising computer readable program instructions stored on a computer readable medium (for example, the memory 44) and executed by a processing device (for example, the processor 42), or a combination thereof that is configured to receive and/or transmit data from/to the mobile terminals 10 or other network entities. In some example embodiments, the communication interface 46 is at least partially embodied as or otherwise controlled by the processor 42. In this regard, the communication interface 46 may be in communication with the processor 42, such as via a bus. The communication interface 46 may include, for example, an antenna, a transmitter, a receiver, a transceiver and/or supporting hardware or software for enabling communications with one or more entities of the system. The communication interface 46 may be configured to receive and/or transmit data using any protocol that may be used for communications between entities of the system over the network 50. The communication interface 46 may additionally be in communication with the memory 44, such as via a bus.

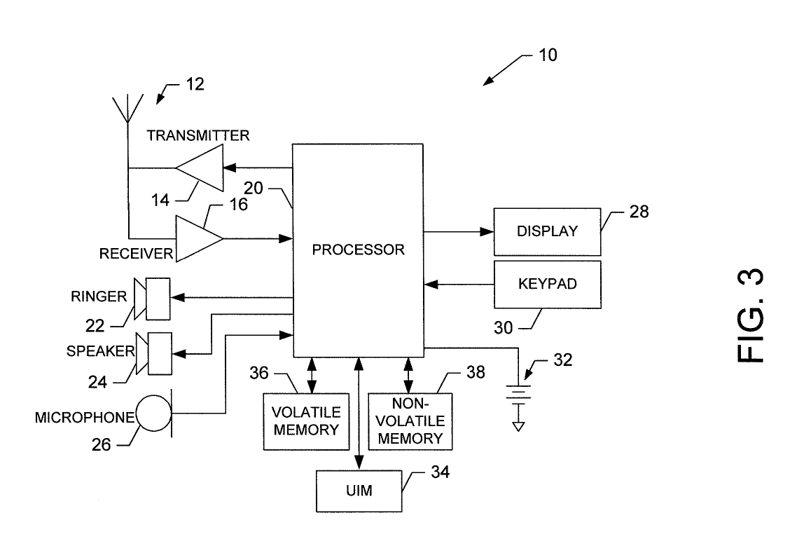

With respect to the mobile terminals 10, FIG. 3 illustrates one example embodiment, of a mobile terminal that may be employed. It should be understood, however, that the mobile terminal 10 as illustrated and hereinafter described is merely illustrative of one type of device that may benefit from various embodiments and, therefore, should not be taken to limit the scope of embodiments. As such, numerous types of mobile terminals, such as portable digital assistants (PDAs), mobile telephones, pagers, mobile televisions, gaming devices, laptop computers, cameras, video recorders, audio/video players, radios, positioning devices (for example, global positioning system (GPS) devices), or any combination of the aforementioned, and other types of voice and text communications systems, may readily employ various embodiments.

The mobile terminal 10 may include an antenna 12 (or multiple antennas) in operable communication with a transmitter 14 and a receiver 16. The mobile terminal 10 may further include an apparatus, such as a processor 20 or other processing device, which provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN, with fourth-generation (4G) wireless communication protocols or the like. As an alternative (or additionally), the mobile terminal 10 may be capable of operating in accordance with non-cellular communication mechanisms.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), and the like. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

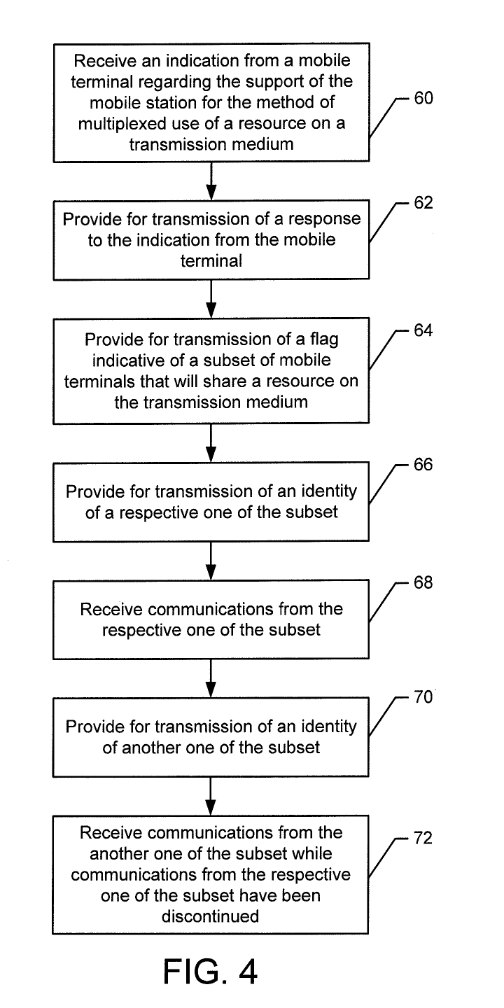

As shown in operation 60 of FIG. 4 from the perspective of a network entity, such as a BSS 40, an apparatus is provided that include means, such as a processor 42, the communication interface 46 or the like, for receiving an indication from a mobile terminal 10 regarding the multiplexing capabilities of the mobile terminal including an indication that the mobile terminal will support the multiplexed use of a resource on a transmission medium. By way of example, an uplink PDCH will be described hereinafter as one, but not necessarily the only, resource on the transmission medium that may be multiplexed in accordance with an example embodiment of the present invention. In response to the indication from the mobile terminal 10 that the mobile terminal will support the multiplexed use of the resource on the transmission medium, the apparatus may include means, such as the processor 42, the communication interface 46 or the like, for providing for transmission of a response to the indication that was received from the mobile terminal 10. See operation 62 of FIG. 4. The response is directed to the mobile terminal 10 and, in addition to acknowledging receipt of the indication from the mobile terminal, may also provide the mobile terminal with information regarding the manner in which the mobile terminal should commence communications utilizing the multiplexed resource of the transmission medium, as described in more detail below.

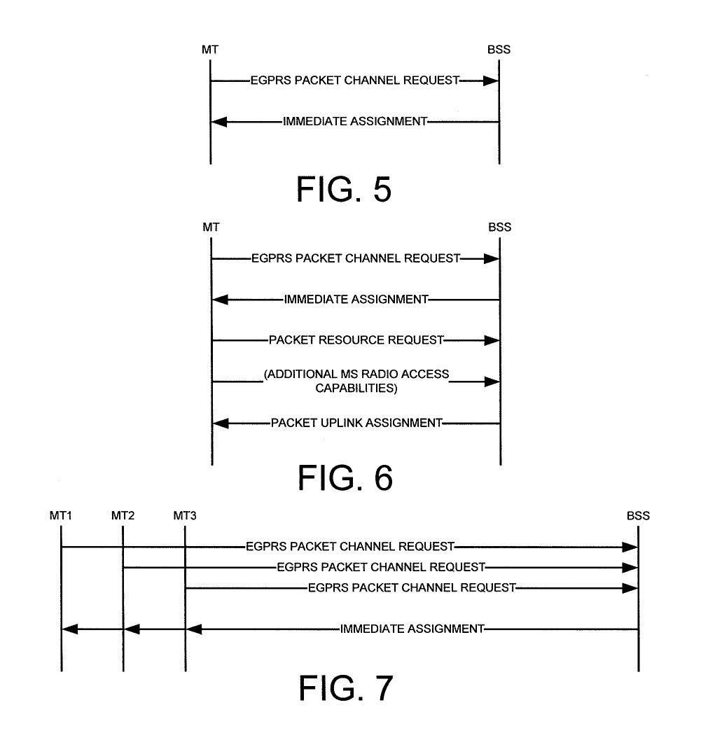

The exchange of messages between a mobile terminal 10 and an apparatus embodied, for example, by a network entity, such as the BSS 40, may be structured in various different manners. In a GERAN system in which the apparatus is embodied by a BSS 40, the mobile terminal 10 and the BSS may exchange messages as shown in FIG. 5 in accordance with one example embodiment of the present invention. In this example embodiment, the mobile terminal 10 may initially transmit an EGPRS PACKET

CHANNEL REQUEST message to the BSS 40 that includes the indication that the mobile terminal will support further multiplexed use of the resource, such as the uplink PDCH. The indication provided by the mobile terminal 10 in association with the EGPRS PACKET CHANNEL REQUEST message may take a number of different forms but, in one embodiment, is implemented as a unique bit sequence or format of the random access burst. Upon receiving the EGPRS PACKET CHANNEL REQUEST message and recognizing the indication provided with the EGPRS PACKET CHANNEL REQUEST message, the BSS 40 may issue an IMMEDIATE ASSIGNMENT message which includes the packet uplink assignment structure. As described below, the packet uplink assignment structure provided by the BSS 40 to the mobile terminal 10 may include information instructing the mobile terminal as to the manner in which to commence communications via the uplink PDCH. While examples of the messages that may be exchanged between the mobile terminal 10 and the BSS 40 are provided in conjunction with the embodiment of FIG. 5 for purposes of illustration, the mobile terminal and/or the BSS may exchange other messages for providing the indication from the mobile terminal and the corresponding response from the BSS. For example, the mobile terminal 10 may provide the indication via a CHANNEL REQUEST message directed to the BSS 40, as opposed to the EGPRS PACKET CHANNEL REQUEST message.

By way of another example of an exchange between the mobile terminal 10 and the BSS 40 in order to advise the BSS of the capability of the mobile terminal to support further multiplexed use of the resource, such as the uplink PDCH, reference is now made to FIG. 6. In this embodiment, the BSS 40 may receive the EGPRS PACKET CHANNEL REQUEST message from the mobile terminal 10. Unlike the embodiment of FIG. 5, however, the EGPRS PACKET CHANNEL REQUEST message of the embodiment of FIG. 6 is not changed so as to include an indication of the support of the mobile terminal 10 for further multiplexed use of the resource. As such, following the transmission of the IMMEDIATE ASSIGNMENT message from the BSS 40 to the mobile terminal 10, the BSS 40 may receive a PACKET RESOURCE REQUEST message and an ADDITIONAL MS RADIO ACCESS CAPABILITIES message from the mobile terminal 10 which includes the indication that the mobile terminal will support further multiplexed use of the resource of the transmission medium. The BSS 40 may then provide for transmission of a response, such as a PACKET UPLINK ASSIGNMENT message with information regarding the manner in which the mobile terminal 10 should commence communications utilizing the multiplexed resource of the transmission medium.

In one example embodiment, the apparatus embodied for example, by the BSS 40, may receive indications from a plurality of mobile terminals 10 indicating that the plurality of mobile terminals support additional multiplexed use of the resource of a transmission medium. Although the apparatus may respond to each mobile terminal 10 via a separate message as described above in conjunction with the examples of FIGS. 5 and 6, the apparatus of one example embodiment may be configured to respond to the plurality of mobile terminals via a single message as shown, for example, in FIG. 7. In this example embodiment, the apparatus embodied, for example, by the BSS 40 may receive an indication from each of three mobile terminals 10 designated as MT1, MT2 and MT3 in FIG. 7 indicating that the mobile terminals support further multiplexed use of the resource, such as uplink PDCH. As shown in FIG. 7, the indications provided by the mobile terminals 10 may be included within or otherwise associated with an EGPRS PACKET CHANNEL REQUEST message. The BSS 40 may then cause a single response, such as an IMMEDIATE ASSIGNMENT message, to be transmitted to each of the mobile terminals 10. The mobile terminals 10 that are to receive the response from the BSS 40 may be addressed or otherwise identified in various manners. For example, the indication received by the BSS 40 from each of the mobile terminals 10 may include or be associated with an address or other random reference associated with the respective mobile terminals. For example, the EGPRS PACKET CHANNEL REQUEST message from each mobile terminal may include the address or a respective random reference for the respective mobile terminal. Thus, the response that is transmitted by the BSS 40 may be addressed to the various mobile terminals 10 based upon the addresses or random references that were provided by the mobile terminals.

The response, such as the IMMEDIATE ASSIGNMENT message, that is transmitted by the BSS 40 may include a plurality of parameters that may be relevant to subsequent communications between the respective mobile terminals 10 and the BSS. In this regard, the parameters may be either specific to a respective mobile terminal 10 or may be common or shared by each mobile terminal to which the response, such as the IMMEDIATE ASSIGNMENT message, is addressed. By way of example and without limitation, the parameters that may be provided by the BSS 40 to the mobile terminals 10 may include an initial timing advance, timing advance index (TAI), radio resources, such as channel description, mobile allocation, etc., power control parameters, request reference, temporary block flow identity (TFI), USF and the channel coding scheme. Of these, the initial timing advance, the power control parameters, the request reference and the TFI may be specific or individual to each mobile terminal 10, while the radio resource, the USF and the channel coding scheme may be shared or common between each of a plurality of mobile terminals. As to the TAI, the TAI may be specific or individual to each mobile terminal or may be reallocated each time the uplink temporary block flow (TBF) switches. While the channel coding scheme may be shared or common amongst the plurality of mobile terminals 10 as noted above, the channel coding scheme may also be individual or specific for each mobile terminal if the channel coding scheme is derived from the signal strength of the access burst as measured by the network. In one embodiment, the list of request references, one of which is provided for each mobile terminal 10, may be improved or optimized by utilizing an offset value from the lowest frame member of the corresponding EGPRS PACKET CHANNEL REQUEST message addressed in the assignment message.

Following the indication by one or more mobile terminals 10 that the mobile terminals support further multiplexed use of the resource and the response from the apparatus, such as the BSS 40, to the mobile terminal, the apparatus embodied, for example, by the BSS may signal to the mobile terminal so as to provide for the further multiplexed use of the resource. As shown in FIG. 4, the apparatus may include means, such as a processor 42, the communication interface 46 or the like, for providing for transmission of a flag which indicates to a subset of mobile terminals 10 that a resource on the transmission medium that is shared by the subset will be allocated to respective ones of the subset. See operation 64 of FIG. 4. By way of example, the BSS 40 of a GERAN system may transmit a radio link control/medium access control (RLC/MAC) block on the downlink PDCH having a header that includes a USF indicating that the mobile terminal 10 identified by the USF will be allocated the resource, such as the uplink PDCH. In contrast to a practice in which the USF has a plurality of unique values that are each associated with or assigned to a single mobile terminal, at least one unique value of the USF may be associated with or assigned to a plurality of mobile terminals 10 in accordance with an example embodiment of the present invention. Based upon the value of the USF alone, the mobile terminals 10 of this example embodiment would not be able to determine which of the mobile terminals was allocated the resource. As such, the apparatus embodied, for example, by the BSS may include means, such as a processor 42, the communication interface 46 or the like, for providing for transmission of an identity of the respective one of the subset that is allocated the resource from the transmission medium. See operation 66 of FIG. 4. In one embodiment, for example, each mobile terminal 10 of the subset that shares a USF value may be assigned a different TFI value. As such, the apparatus of this embodiment may be configured to transmit a TFI value so as to identify the respective one of the subset of mobile terminals 10 that is allocated the resource.

While the identity may be transmitted from the apparatus, such as the BSS 40, to the mobile terminals 10 in a variety of manners, the apparatus of one example embodiment is configured to provide for the transmission of a PACKET UPLINK ACK/NACK (PUAN) message that includes the identity, such as the TFI, of the respective one of the subset that is allocated a resource. In a GERAN system, the apparatus may utilize the PUAN message to provide the identity since the PUAN message is required in at least certain situations. In this regard, the most common RLC mode is the RLC acknowledge mode which relies on the provisioning of ACK/NACK information. Thus, the transmission of a PUAN message is necessary during temporary block flow. Additionally, the PUAN message may also be utilized in other RLC modes, although the PUAN message may not be absolutely necessary. However, the apparatus may utilize other messages, such as a PACKET UPLINK ASSIGNMENT message, in order to provide the identity to the mobile terminals 10.

In instances in which another mobile terminal is currently utilizing the resource, such as by currently transmitting data via the uplink PDCH, the apparatus may not only need to identify the mobile terminal 10 that is to be allocated the respective resource, but may also need to notify the mobile terminal that is currently utilizing the resource that it will no longer be allocated the resource. As such, the apparatus embodied, for example, by the BSS 40 may include means, such as the processor 42, communication interface 46 or the like, for providing the flag and the identity not only to the respective one of the mobile terminals 10 that is to be allocated the resource, but also to at least the mobile terminal that is currently or was previously utilizing the resource such that the mobile terminal that is currently or was previously utilizing the resource will cease its use of the resource concurrent with or slightly prior to the use of the resource by the respective one of the mobile terminals that is identified by the flag and the identity.

After having provided a flag and an identity to identify the respective mobile terminal 10 as being allocated the resource, such as the uplink PDCH, the apparatus embodied, for example, by the BSS 40 may include means, such as a processor 42, the communication interface 46 or the like, for receiving communications, utilizing the multiplexed resource, from the mobile terminal 10 that was identified. See operation 68 of FIG. 4. In instances in which both mobile terminals 10, that is, the first mobile terminal that was previously utilizing the resource and the second mobile terminal that is to be allocated the resource, successfully receive the flag and the identity from the apparatus, the first mobile terminal that was previously utilizing the resource will cease its use of the resource prior to or concurrent with the commencement of the use of the resource by the second mobile terminal. If, however, the first mobile terminal that was previously utilizing the resource successfully receives the flag and the identity from the apparatus, but the second mobile terminal that is to be allocated the resource fails to successfully receive the flag and the identity, the first mobile terminal that was previously utilizing the resource will cease its use of the resource, but the second mobile terminal will not commence its use of the resource. In some instances, the apparatus may detect this situation by the failure of a packet to be transmitted via the uplink PDCH such that the apparatus may again notify the second mobile terminal that is to be assigned the resource of the flag and the identity such that the second mobile terminal may commence use of the resource. In the extended uplink TBF mode, however, the second mobile terminal is not required to transmit any data, such as an RLC/MAC block, upon the reception out the flag and the identity if the second mobile terminal does not have any data to transmit. In this mode, the apparatus cannot determine if the second mobile terminal failed to receive the flag or the identity or if the second mobile terminal simply does not have any data to transmit. In order to avoid this indeterminate situation, the second mobile terminal may be configured to transmit a dummy block via the uplink PDCH such that the apparatus can discern that the mobile terminal correctly received a flag and the identity, but simply does not have any data to transmit via the uplink PDCH.

In an instance in which the first mobile terminal fails to successfully receive the flag and the identity, but the second mobile terminal does successfully receive the flag and the identity, the first mobile terminal will continue its use of the resource, such as by transmitting data via the uplink PDCH, while the second mobile terminal also begins its use of the resource, such as by also attempting to transmit data via the uplink PDCH. The resulting collision in the uplink PDCH will provide an indication to the apparatus as to the failure of the first mobile terminal to successfully receive the flag and the identity. In order to avoid such collisions, the apparatus may poll the first mobile terminal for the PUAN message and be able to determine if the first mobile terminal failed to successfully receive the flag and the identity. While waiting for the PUAN message from the first mobile terminal, the apparatus may be configured to schedule use of the resource by the second mobile terminal using a different value of the USF. Still further, both mobile terminals may fail to receive the flag and/or the identity. In this instance, the first mobile terminal may continue its use of the resource, while the second mobile terminal continues not to make use of the resource. While this situation does not result in a collision in the uplink PDCH, a different mobile terminal than that intended to utilize the resource may continue its use of the resource.

Returning to the embodiment of FIG. 4, the apparatus embodied, for example, by the BSS 40 or other network entity may continue to receive communications from the respective mobile terminal. In the illustrated embodiment, the apparatus may desire to allocate the resource to another mobile terminal. As such, the apparatus may include means, such as the processor 42, the communication interface 46 or the like, for providing for transmission of an identity, e.g., TFI, of another one of the subset or a flag associated with another mobile terminal that may not be a member of the subset. See operation 70 of FIG. 4. As noted above, the identity may be transmitted not only to the mobile terminal to be allocated the resource, but also the mobile terminal previously or currently allocated the resource such that the mobile terminal that was previously or is currently allocated the resource. As such, the apparatus may include means, such as the processor 42, communications interface 44 or the like, for receiving communications from another one of the subset, while communications from the mobile terminal that was previously allocated the resource are discontinued. See operation 72. Thus, the apparatus of one example embodiment may efficiently switch the allocation of the resource from one mobile terminal to another mobile terminal, such as in accordance with a schedule of resource allocation.

By way of example, the following table indicates a situation in which the apparatus embodied, for example, by the BSS 40 or other network entity, has issued three different identities, namely, TFI=0, TFI=1 and TFI=2, for three mobile terminals designated MT1, MT2 and MT3, respectively, that are assigned to a USF having a value of 1. For example, the apparatus may assign the three different identities on four time slots using enhanced dynamic allocation, e.g., time slot number (TN) TN0-TN3. In addition to the mobile terminals associated with USF 1, there may be other mobile terminals utilizing the same resource that have different USF values, such as another mobile terminal that is assigned an identity of TFI=4 and is associated with a USF value of 2. Prior to the commencement of the following table, the apparatus may have identified a mobile terminal that was to be allocated the uplink PDCH by USF 1 and a TFI equal to 0.

As shown in the foregoing table, during periods B0 and B1, a mobile terminal associated with USF 1 and TFI=0 is allocated the uplink PDCH for data transmission during each time slot. In period B1, it is noted that the apparatus identifies the mobile terminal to be allocated the resource beginning with period B2 as the mobile terminal associated with a USF value of 2. As noted above, the mobile terminal having a USF value of 2 is a single mobile terminal having a TFI equal to 4. As such, the mobile terminal associated with USF 2 and a TFI equal to 4 may then utilize the resource by transmitting data via the uplink PDCH during periods B2 and B3. In addition to identifying the mobile terminal associated with USF having a value of 2, the apparatus may also transmit a PUAN message during period B1 to the mobile terminal associated with a TFI value of 0 and the mobile terminal associated with a TFI value of 1. The PAUN message includes a TFI value of 1 to indicate that the next mobile terminal of the subset associated with USF 1 to utilize the resource is the mobile terminal associated with a TFI value of 1. In response to the PAUN message including a TFI value of 1, the mobile terminal having a TFI value of 0 will discontinue further use of the resource, such as by ceasing transmission of data via the uplink PDCH, and the mobile terminal having a TFI value of 1 will await receipt of a USF value of 1 in order to commence use of the resource, such as by commencing transmission of data via the uplink PDCH. As such, the PUAN message may be addressed to the mobile terminal associated with a TFI value of 0 and to the mobile terminal associated with a TFI value of 1, may include ACK/NACK information for the mobile terminal associated with a TFI value of 0 and may also indicate that the next mobile terminal from among the subset of mobile terminals having a USF value of 1 to be allocated the resource will be the mobile terminal associated with a TFI value of 1. Thereafter, the apparatus may identify the mobile terminal associated with a USF having a value of 1 in periods B3 and B4. Since the apparatus previously indicated that the next mobile terminal of the subset associated with USF 1 to utilize the resource is the mobile terminal associated with a TFI value of 1, the uplink PDCH will then be allocated to the mobile terminal having a USF value of 1 and a TFI value of 1 as shown during periods B4 and B5. Additionally, the apparatus may signal, during period B3, the mobile terminal associated with a USF value of 2 and may indicate that the mobile terminal associated with a USF value of 2 will no longer be allocated the resource, such that the mobile terminal associated with a USF value of 2 will discontinue use of the resource beginning with period B4. As the foregoing example illustrates, by permitting multiple mobile terminals 10 that are each assigned the same flag value, such as the same value of the USF, to be individually allocated a resource by identifying which respective one of the plurality of mobile terminals having the same flag value is to be allocated the resource, additional mobile terminals may utilize the same resource in a multiplexed fashion in accordance with an example embodiment of the present invention. As described above, the mobile terminal 10 is not permitted to utilize the resource until the mobile terminal has received the identity, such as by receiving a PUAN message including a TFI value associated with the respective mobile terminal. As such, the initial mobile terminal must also await the identity, such as provided via a PUAN message, even though there are no other mobile terminals to be allocated the resource. Thus, the apparatus of this embodiment may disadvantageously be required to cause an additional message to be transmitted that provides the identity of the mobile terminal, such as by transmitting an additional PUAN message. In order to avoid the transmission of this additional message, the apparatus may be configured to signal to the mobile terminal in another message, such as in the assignment and reconfiguration messages, as to whether the mobile terminal should respond to the assigned USF by beginning use of the resource or whether the mobile terminal should wait for the identity of the mobile terminal to be provided, such as via a PUAN message prior to commencing use of the resource. In the case of the initial mobile terminal, the transmission of an additional message, that is, a PUAN message, may be avoided in this embodiment by advising the initial mobile terminal to commence use of the resource upon receipt of its USF value.

The further multiplexed use of a resource provided by an example embodiment of the present invention may be utilized in conjunction with various medium access modes including, for example, different multislot configuration. By way of example, three mobile terminals may have different multislot configurations, such as a first mobile terminal being assigned TN0-TN1, a second mobile terminal being assigned TN1-TN2 and a third mobile terminal being assigned TN2-TN4 while making use of the increased multiplexed use of the resource in accordance with an example embodiment of the present invention.

Comparable to the manner in which an example embodiment of the present invention was described in conjunction with a network entity such as an apparatus embodied by the BSS 40, an apparatus may be embodied by the mobile terminal 10 in order to communicate with the network and to respond appropriately in response to the flag and identity. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

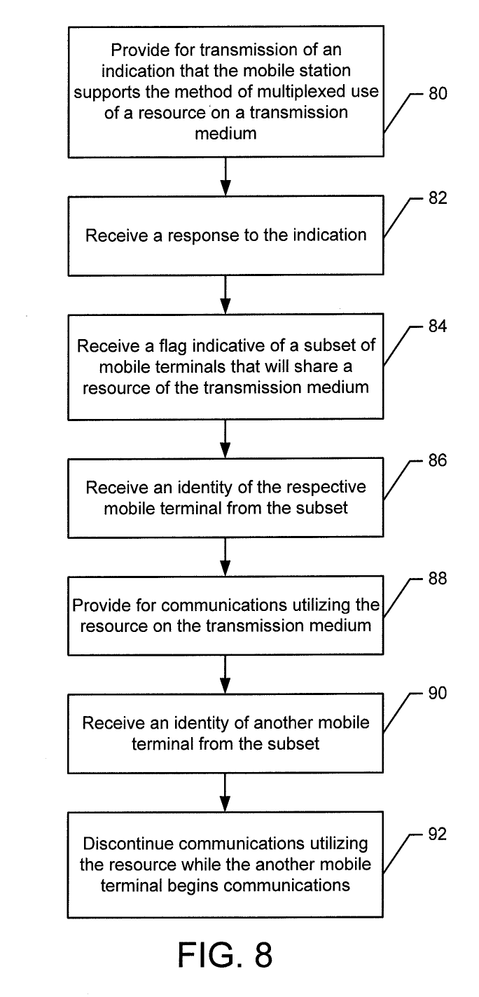

In one embodiment, the apparatus embodied, for example, by the mobile terminal 10 may include means, such as a processor 20, transmitter 14, antenna 12 or the like, for providing for transmission of an indication that the mobile terminal will support the multiplexed use of a resource on the transmission medium, such as the uplink PDCH. See operation 80 of FIG. 8. The apparatus of this example embodiment may also include means, such as the processor 20, the receiver 16, the antenna 12 or the like, for receiving a response to the indication that indicates, potentially among other things, whether the mobile terminal 10 should await reception of the identity of the mobile station prior to commencing communications in response to reception of the flag. See operation 82 of FIG. 8. Thereafter, the apparatus may include means, such as a processor 20, the receiver 16, the antenna 12 or the like, for receiving a flag which indicates that a resource of a transmission medium that is shared by a subset of mobile terminals 10 will be allocated to a respective one of the subset. See operation 84. The apparatus may also include means, such as the processor 20, the receiver 16, the antenna 12 or the like, for receiving an identity of the respective one of the subset to which the resource on the transmission medium is allocated. See operation 86 of FIG. 8. In instances in which the flag and the identity are associated with the respective mobile terminal 10, the apparatus may include means, such as the processor 20, the transmitter 14, the antenna 12 or the like, for providing for communications to the network 50, utilizing the resource on the transmission medium, such as the uplink PDCH. See operation 88. The apparatus may then continue to provide for transmission utilizing the resource until receiving the identity of another of the subset to be allocated the resource, or until receiving a flag associated with another mobile terminal to be allocated the resource. In this regard, the apparatus may include means, such as the processor 20, the receiver 16, the antenna 12 or the like, for receiving an identity of another one of the subset and then discontinuing the transmission utilizing the resource of the transmission medium, thereby avoiding a collision, such as on the uplink PDCH. See operations 90 and 92 of FIG. 8

FIGS. 4 and 8 are flowcharts of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above in conjunction with FIG. 4 may be stored by a memory device 44 of a network entity, such as the BSS 40, and executed by a processor 42 of the network entity. Likewise, the computer program instructions which embody the procedures described above in conjunction with FIG. 8 may be stored by a memory device 36, 38 of a mobile terminal 10 and executed by a processor 20 in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
providing for transmission of a flag which indicates to a subset of mobile stations that a resource on a transmission medium that is shared by the subset will be allocated to a respective one of the subset;
providing for transmission of an identity of the respective one of the subset; and
receiving communications from the respective one of the subset utilizing the resource on the transmission medium.

2. A method according to claim 1 wherein the resource on the transmission medium comprises an uplink data channel and wherein receiving communications comprises receiving data from the respective one of the subset via the uplink data channel.

3. A method according to claim 1 further comprising providing for transmission of an identity of another one of the subset to at least the respective one of the subset and the another one of the subset following receipt of communications from the respective one of the subset and thereafter receiving communications from the another one of the subset utilizing the resource on the transmission medium while the communications from the respective one of the subset have been discontinued.

4. (canceled)

5. (canceled)

6. (canceled)

7. (canceled)

8. (canceled)

9. An apparatus comprising at least one processor and at least one memory storing computer program code, wherein the at least one memory and stored computer program code are configured, with the at least one processor, to cause the apparatus to at least:
provide for transmission of a flag which indicates to a subset of mobile stations that a resource on a transmission medium that is shared by the subset will be allocated to a respective one of the subset;
provide for transmission of an identity of the respective one of the subset; and
receive communications from the respective one of the subset utilizing the resource on the transmission medium.

10. An apparatus according to claim 9 wherein the resource on the transmission medium comprises an uplink data channel, and wherein the at least one memory and stored computer program code are configured, with the at least one processor, to receive communications by receiving data from the respective one of the subset via the uplink data channel.

11. An apparatus according to claim 9 wherein the at least one memory and stored computer program code are configured, with the at least one processor, to further cause the apparatus to provide for transmission of an identity of another one of the subset to at least the respective one of the subset and the another one of the subset following receipt of communications from the respective one of the subset and thereafter receive communications from the another one of the subset utilizing the resource on the transmission medium while the communications from the respective one of the subset have been discontinued.

12. An apparatus according to claim 9 wherein the at least one memory and stored computer program code are configured, with the at least one processor, to further cause the apparatus to provide for transmission of the identity by providing for transmission of a Packet Uplink Ack/Nack (PAUN) message that includes the identity of the respective one of the subset.

13. An apparatus according to claim 9 wherein the at least one memory and stored computer program code are configured, with the at least one processor, to further cause the apparatus to receive an indication from a mobile station that the mobile station supports multiplexed use of the resource on the transmission medium.

14. (canceled)

15. (canceled)

16. (canceled)

17. A computer program product comprising at least one computer-readable medium having computer-readable program instructions stored therein, the computer-readable program instructions comprising:
program instructions configured to provide for transmission of a flag which indicates to a subset of mobile stations that a resource on a transmission medium that is shared by the subset will be allocated to a respective one of the subset;
program instructions configured to provide for transmission of an identity of the respective one of the subset; and
program instructions configured to receive communications from the respective one of the subset utilizing the resource on the transmission medium.

18. (canceled)

19. (canceled)

20. (canceled)

21. A method comprising:
receiving a flag which indicates that a resource on a transmission medium that is shared by a subset of mobile stations will be allocated to a respective one of the subset;
receiving an identity of the respective one of the subset to which the resource on the transmission medium is allocated; and
providing for transmission utilizing the resource on the transmission medium.

22. A method according to claim 21 wherein the resource on the transmission medium comprises an uplink data channel, and wherein providing for transmission comprises providing for transmission of data via the uplink data channel.

23. A method according to claim 21 further comprising receiving an identity of another one of the subset following the transmission utilizing the resource on the transmission medium and thereafter discontinuing the transmission utilizing the resource on the transmission medium.

24. A method according to claim 21 wherein receiving the identity comprises receiving a Packet Uplink Ack/Nack (PAUN) message that includes the identity of the respective one of the subset.

25. (canceled)

26. (canceled)

27. (canceled)

28. An apparatus comprising at least one processor and at least one memory storing computer program code, wherein the at least one memory and stored computer program code are configured, with the at least one processor, to cause the apparatus to at least:
receive a flag which indicates that a resource on a transmission medium that is shared by a subset of mobile stations will be allocated to a respective one of the subset;
receive an identity of the respective one of the subset to which the resource on the transmission medium is allocated; and
provide for transmission utilizing the resource on the transmission medium.

29. An apparatus according to claim 28 wherein the resource on the transmission medium comprises an uplink data channel, and wherein the at least one memory and stored computer program code are configured, with the at least one processor, to provide for transmission by providing for transmission of data via the uplink data channel.

30. An apparatus according to claim 28 wherein the at least one memory and stored computer program code are configured, with the at least one processor, to further cause the apparatus to receive an identity of another one of the subset following the transmission utilizing the resource on the transmission medium and thereafter discontinue the transmission utilizing the resource on the transmission medium.

31. An apparatus according to claim 28 wherein the at least one memory and stored computer program code are configured, with the at least one processor, to further cause the apparatus to receive the identity by receiving a Packet Uplink Ack/Nack (PAUN) message that includes the identity of the respective one of the subset.

32. An apparatus according to claim 28 wherein the at least one memory and stored computer program code are configured, with the at least one processor, to further cause the apparatus to provide for transmission of an indication that the mobile station supports multiplexed use of the resource on the transmission medium.

33. An apparatus according to claim 32 wherein the at least one memory and stored computer program code are configured, with the at least one processor, to further cause the apparatus to receive a response to the indication that indicates whether the mobile station should await reception of the identity of the mobile station prior to commencing communications in response to reception of the flag.

34. (canceled)

35. A computer program product comprising at least one computer-readable medium having computer-readable program instructions stored therein, the computer-readable program instructions comprising:
program instructions configured to receive a flag which indicates that a resource on a transmission medium that is shared by a subset of mobile stations will be allocated to a respective one of the subset;
program instructions configured to receive an identity of the respective one of the subset to which the resource on the transmission medium is allocated; and
program instructions configured to provide for transmission utilizing the resource on the transmission medium.

36-38. (canceled)
